(19) United States
(12) Patent Application Publication
(10) Pub. No.: US 2011/0064260 A1
(43) Pub. Date: Mar. 17, 2011

(54) INSERT MOLDED SUSPENSION MEMBER WITH MECHANICAL SUPPORT

(75) Inventors: Morten Kjeldsen Andersen, Odder (DK); Leif Johannsen, Odder (DK)

(73) Assignee: Pulse HVT ApS, Horsens (DK)

(21) Appl. No.: 12/872,422

(22) Filed: Aug. 31, 2010

Related U.S. Application Data
(63) Continuation-in-part of application No. 11/525,002, filed on Sep. 21, 2006.
(60) Provisional application No. 60/719,104, filed on Sep. 21, 2005.

(51) Int. Cl. H04R 11/02

(52) U.S. Cl. 381/430; 381/423

(57) ABSTRACT

A suspension member for a diaphragm, the suspension member comprising a first portion being adapted to be coupled to a substantially stiff piston part, a second portion integrated with a substantially stiff support member suitable for acoustic sealing purposes, and a flexible member connecting the first and second portions.

### CROSS-REFERENCE TO RELATED APPLICATION

This application is a continuation-in-part of prior application Ser. No. 11/525,002, filed Sep. 21, 2006, entitled “Insert Molded Surround with Mechanical Support, which claims the benefit of U.S. Provisional Application No. 60/719,104, filed Sep. 21, 2005 entitled “Insert Molded Surround with Mechanical Support”, both of which are incorporated herein by reference in their respective entireties.

### FIELD OF THE INVENTION

The present invention relates to a molded suspension member with a mechanical support. In particular, the present invention relates to molded suspension member of silicone, rubber or any other soft material having a mechanical support integrated therewith in order to ease handling of the suspension member, and in order to provide an acoustical seal in an assembled miniature transducer.

### BACKGROUND OF THE INVENTION

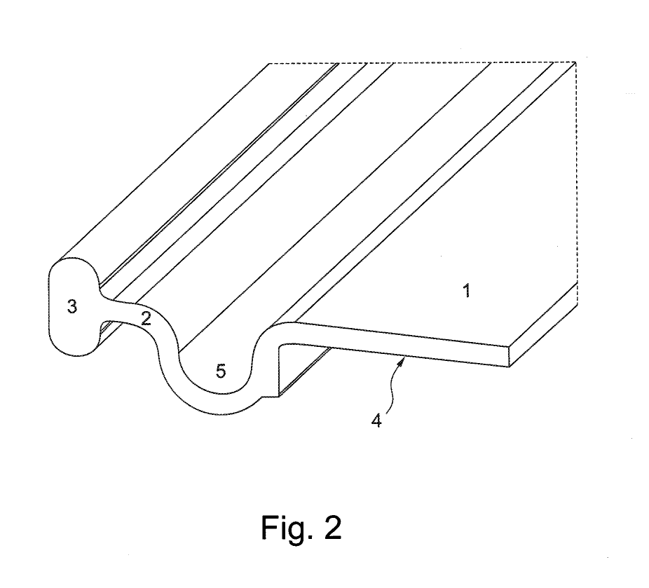

U.S. Pat. No. 5,574,797 relates to a suspension member for traditional cone-shaped loudspeakers. In order to ease fixation of the suspension member to a loudspeaker frame a peripheral ring made of for example aluminum is provided in an outer part of the suspension member, cf. reference numeral 15′ in FIG. 2 of U.S. Pat. No. 5,574,797.

The peripheral ring 15′ suggested in U.S. Pat. No. 5,574,797 is made of a material being different from the material of the suspension member itself, the latter being made of an injection moldable and high-temperature resistant elastomer.

It is a drawback of the suspension member suggested in U.S. Pat. No. 5,574,797 that the peripheral ring needs to be manufactured in a separate process. Thus, in order to manufacture the suspension member suggested in U.S. Pat. No. 5,574,797 the peripheral ring and the injection moldable part of the suspension member are manufactured separately before being assembled to form the final suspension member. In a mass production facility the separate manufacturing of the peripheral ring and the injection moldable part of the suspension member and the subsequent assembling of the two parts increase the manufacturing costs unnecessary.

It may be seen as an object of the present invention to provide a suspension member which is easy to handle during manufacturing.

It may be seen as a further object of the present invention to provide a suspension member comprising an integrated mechanical support member having appropriate acoustical sealing properties.

### SUMMARY OF THE INVENTION

The above-mentioned objects are complied with by providing, in a first aspect, a suspension member for a diaphragm, the suspension member comprising:
a first portion being adapted to be coupled to a piston;
a second portion comprising an integrated, substantially stiff support member having a cross-sectional profile suitable for acoustical sealing purposes; and
a flexible member connecting the first and second portions.

It is an advantage of the present invention that the assembly process of a micro-loudspeaker becomes significantly easier, because the mechanical support member can be used to handle and centre the suspension member for further processing.

The mechanical support member is integrated with the second portion of the suspension member, also called a surround. Thus, the second portion and the support member is fabricated from the same material, and fabricated in the same manufacturing process, such as an injection molding process.

The fact that the support member is suitable for acoustical sealing purposes means that the support member, when positioned between two properly shaped members under a given pressure, provides an acoustical sealing one side of the suspension member to the other side of the suspension member. Typically, the support member provides an acoustical sealing between a front chamber and a back chamber of a transducer.

The support member may have a substantially circular, an oval, an elliptical, a substantial rectangular or a substantially quadratic cross-sectional profile.

It is another advantage of the present invention that the support member is suitable for forming an acoustical seal between the front chamber and the back chamber of a miniature electro-acoustic transducer assembly. The terms front chamber and back chamber are defined as the regions in front of the diaphragm and behind the diaphragm, respectively.

The flexible member may comprise at least one electrically conductive element adapted to transport electrical signals across the suspension member, for example, signals between one or more circuits arranged on the second portion side of the suspension member and one or more circuits arranged on the piston. Such circuits may include circuits for signal processing, circuits to be at least partly positioned and operated in an air gap in an associated magnetic circuit, etc. The signals to be transported across the suspension member may be power supply signals, data signal signals, synchronising signals, etc.

The at least one electrically conductive element may be at least partly embedded into the flexible member having a first free end in the vicinity of the first portion and a second free end in the vicinity of the second portion. Preferably, the at least one electrically conductive element has the form of a thin electrically conductive wire that is fully, except for the first and second free ends, embedded into the suspension member. The number of wires embedded into the suspension member can be adjusted depending on the specific application of the diaphragm. Thus, the number of wires may in principle be chosen arbitrarily and the suspension member may thus comprise 1, 2, 4, 6, 10 or even a higher number of wires embedded into the suspension member.

The suspension member itself may comprise a material selected from the group consisting of: silicone, rubber or any combination thereof. However, any soft material with the appropriate mechanical properties may in principle be used. The suspension member may take a substantially circular shape (o-ring), a substantially oval shape or a substantially rectangular shape. However, other shapes may also be applicable.

As already mentioned, the substantially stiff support member forms an integral part of the suspension member whereby the second portion and the support member are fabricated from the same material. Moreover, the second portion and the support member are most likely fabricated in the same manufacturing process, such as in an injection molding process. Suitable injection moldable materials may be silicone, rubber or any combination thereof.

Preferably, the first portion, the second portion and the flexible member are fabricated in the same material, said material being an injection moldable material preferably selected from the group consisting of: silicone, rubber or any combination thereof. The process of fabricating the first portion, the second portion and the flexible member is preferably performed in a same manufacturing process.

In a second aspect, the present invention relates to a diaphragm for a loudspeaker, the diaphragm comprising:
a suspension member according to the first aspect of the present invention, and
a piston secured to the first portion of the suspension member.

The piston may comprise a material selected from a group consisting of: kapton, aluminum, polymer and nylon. Alternatively, the piston may comprise a flex print, optionally with moving coils integrated therein.

In a third aspect, the present invention relates to a loudspeaker comprising a diaphragm according to the second aspect of the present invention.

Finally, the present invention relates to a portable unit comprising at least one loudspeaker according to the third aspect of the present invention, said portable unit being selected from the group consisting of: cellular phones, PDAs, game consoles and portable computers.

### BRIEF DESCRIPTION OF THE INVENTION

The present invention will now be explained in further details with reference to the accompanying figures, wherein

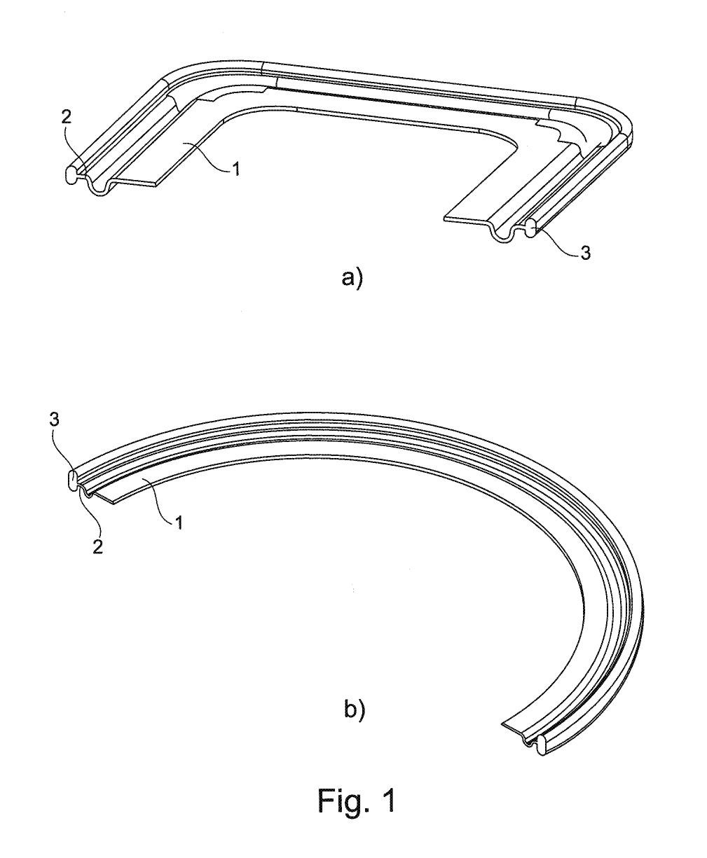

FIG. 1 shows cross-sectional views of embodiments of the present invention;

FIG. 2 shows a close-up of a cross-sectional view of an embodiment of the present invention;

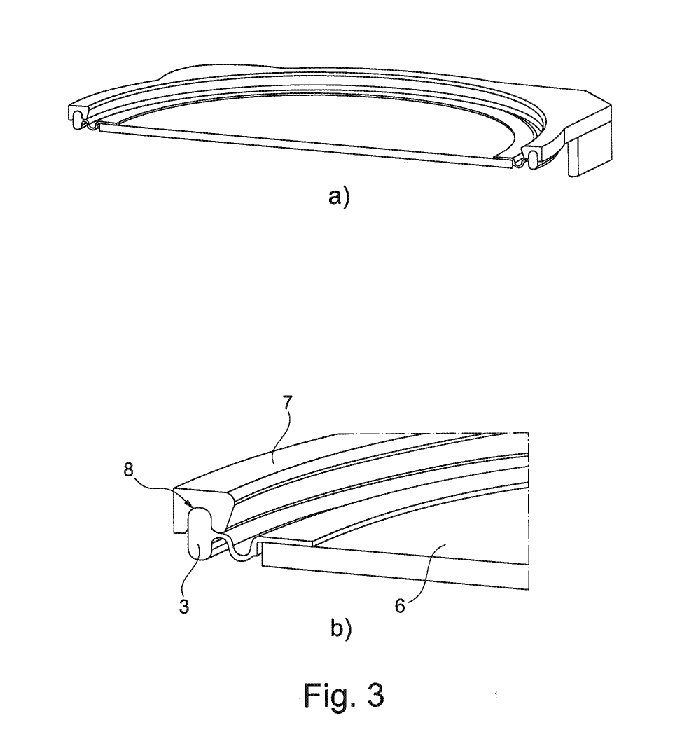

FIG. 3 shows a suspension member, a piston and an upper housing portion; and

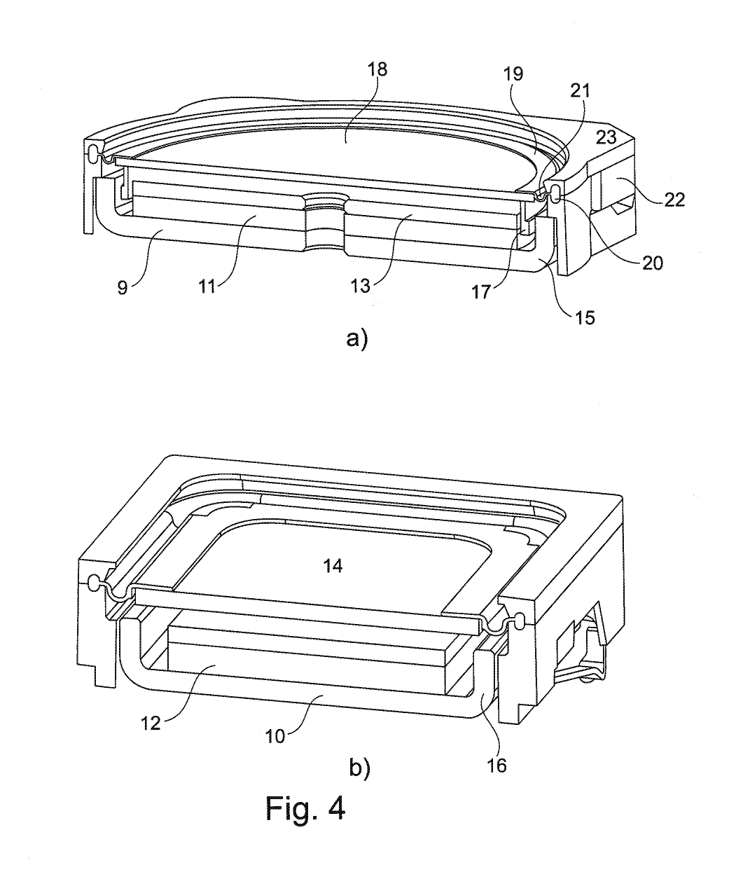

FIG. 4 shows cross-sectional views of a miniature transducer applying the suspension member or diaphragm of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In its most general aspect the present invention relates to a moulded suspension member with a build-in mechanical support member for simplifying the handling of the suspension member. Besides simplifying the handling of the suspension member the build-in mechanical support member is adapted to form an acoustical seal between a front chamber and a back chamber of an assembled transducer.

FIGS. 1a and 1b show embodiments of the present invention in its most simple form. As seen, FIG. 1a shows part of a nearly rectangular shaped suspension member, whereas FIG. 1b shows part of a circular shaped suspension member where the support member 3 forms a peripheral o-ring. Both suspension members have an inner edge 1 and an outer portion 2.

The inner edge 1 is adapted for being attached to a piston part (not shown) whereas the outer portion 2 is attached to a support member 3 for supporting the suspension member. It should be noted that the support member 3 may have a cross-sectional profile being different from the profile depicted in FIG. 1. Thus, the support member 3 may have substantially circular cross-sectional profiles, elliptical profiles, oval profiles, rectangular profiles, quadratic profiles etc. In principle the support member 3 may have any cross-sectional profile.

The support member 3 can be a separate structure which is glued, heated, welded or by other means attached to the outer portion 2. Preferably, the support member 3 forms an integral part of the suspension member in that the support member 3 can be injection molded in the same process as the injection molding of the suspension member.

FIG. 2 shows a close-up view of a suspension member. Along with the first (inner) portion 1, the second (outer) portion 2, and the support member 3, a flexible member 5 is depicted. The flexible member 5 connects the inner and outer portions of the suspension member. A piston (not shown) is to be glued, heated, welded or by other means attached to the lower surface 4 of the inner portion 1.

The suspension member may optionally be implemented with integrated lead-out wires (not shown). Such lead-out wires transport signal across the suspension member, i.e. to and/or from electrical devices arranged on a piston (not shown) attached to the inner portion. Such electrical devices may include wounded coils (moving coils), ASICs or other kinds of electronic circuits or components. The number of integrated lead-out wires is matched to the specific demands. Thus, in case an ASIC is arranged on the piston lead-out wires for power supply, clock signals, data signals, etc. may be provided in order to transport electrical signals across the suspension member.

The molded suspension member itself is made of a soft material, such as silicone, rubber or a similar soft material. The material constituting the suspension member can be chosen independently of the piston material. The piston to be attached to the suspension member is typically made of a stiffer material, such as kapton, aluminum, nylon, flex print etc.

Still referring to FIG. 2 the inner portion 1, the flexible member 5, the outer portion 2 and the support member 3 may advantageously be manufactured, such as injection mounded, in the same manufacturing process. As previously mentioned a piston can be attached to the surface 4 by for example, gluing, heating or ultrasound-based welding.

FIGS. 3a and 3b (close-up of FIG. 3a) show suspension members with a piston 6 attached thereto. Moreover, an upper housing portion 7 is positioned on top of the suspension member. As seen, the upper housing portion 7 comprises a recess 8 which is configured to receive a portion of the support member 3. The recess 8 and the support member 3 form an acoustical seal in combination.

FIGS. 4a and 4b show cross-sectional views miniature transducers applying, among other things, a suspension member and a diaphragm according to the present invention.

The transducer shown in FIGS. 4a and 4b both comprise a motor comprising a yoke 9, 10, a permanent magnet 11, 12 and an inner pole piece 13, 14 arranged on top of the permanent magnet. The edges of the yoke are bended so that they form outer pole pieces 15, 16. A voice coil 17 is positioned in the air gap between the inner and outer pole pieces. The voice coil 17 is attached to a piston 18 which is attached to an inner edge 19 of the suspension member. The inner edge 19 is operationally connected to the oval shaped support member 20 via the flexible member 21.

As seen in FIG. 4a the oval shaped support member 20 is positioned between a lower part 22 and an upper part 23 of a housing of the transducer. In fact, the oval shaped support 20 forms an acoustical seal between the regions below (back chamber) and above (front chamber) the diaphragm. For acoustical reasons it is advantageous to have such an acoustic sealing between back and front chambers.

Even though not depicted, the suspension member shown in FIGS. 4a and 4b may comprise one or more lead out wires for transporting electrical signals across the suspension member. As previously stated such lead out wires can transport electrical signals to/from voice coils, ASICs or other electronic components secured to the diaphragm.

1. A suspension member for a diaphragm, the suspension member comprising:
a first portion being adapted to be coupled to a piston;
a second portion comprising an integrated, substantially stiff support member having a cross-sectional profile suitable for acoustical sealing purposes; and
a flexible member connecting the first and second portions.

2. A suspension member according to claim 1, wherein the flexible member comprises a material selected from the group consisting of: silicone, rubber and any combination thereof.

3. A suspension member according to claim 1, wherein the suspension member takes a substantially circular shape.

4. A suspension member according to claim 1, wherein the suspension member takes a substantially rectangular shape.

5. A suspension member according to claim 1, wherein the second portion, including the integrated, substantially stiff support member, is fabricated of an injection moldable material.

6. suspension member according to claim 5, wherein the injection mouldable material is selected from the group consisting of: silicone, rubber or any combination thereof.

7. A suspension member according to claim 1, wherein the first portion, the second portion and the flexible member are fabricated in the same material, said material being an injection moldable material is selected from the group consisting of: silicone, rubber or any combination thereof.

8. A diaphragm for a loudspeaker, the diaphragm comprising:
a suspension member according to claim 1; and
a piston secured to the first portion of the suspension member.

9. A diaphragm according to claim 8, wherein the piston comprises a material selected from a group consisting of: kapton, aluminum, polymer and nylon.

10. A diaphragm according to claim 8, wherein the piston comprises a flex print.

11. A loudspeaker comprising a diaphragm according to claim 8.

12. A portable unit comprising at least one loudspeaker according to claim 11, said portable unit being selected from the group consisting of: cellular phones, PDAs, game consoles and portable computers.
